(19) United States
(12) Patent Application Publication
(10) Pub. No.: US 2010/0141690 A1
(43) Pub. Date: Jun. 10, 2010

(54) LIGHT-EMITTING ELEMENT DRIVING CIRCUIT

(75) Inventor: Takeshi Arai, Isesaki-City (JP)

Correspondence Address: OSHA LIANG L.L.P., TWO HOUSTON CENTER, 909 FANNIN, SUITE 3500, HOUSTON, TX, 77010, US

(73) Assignees: SANYO ELECTRIC CO., LTD., Osaka (JP); SANYO SEMICONDUCTOR CO., LTD., Ora-Gun (JP)

(21) Appl. No.: 12/633,460

(22) Filed: Dec. 8, 2009

(30) Foreign Application Priority Data
Dec. 9, 2008 (JP) 2008-313315

(51) Int. Cl. G09G 5/10; G06F 3/038; G09G 3/00

(52) U.S. Cl. 345/690; 345/30

(57) ABSTRACT

A light-emitting element driving circuit comprising: an index data storage unit configured to store n-bit index data for each of a plurality of light-emitting elements included in a display device, the n-bit index data specifying a storage location of gradation data indicating brightness of a light-emitting element in the plurality of light-emitting elements: a gradation data storage unit configured to store the gradation data with m bits larger than n bits, corresponding to the index data; and a driving circuit configured to drive the light-emitting element on the basis of the gradation data corresponding to the index data so that the light-emitting element emits light at brightness according to the gradation data.

### CROSS-REFERENCE TO RELATED APPLICATION

This application claims the benefit of priority to Japanese Patent Application No. 2008-313315, filed Dec. 9, 2008, of which full contents are incorporated herein by reference.

### BACKGROUND OF THE INVENTION

1. Field of the Invention

The present invention relates to a light-emitting element driving circuit.

2. Description of the Related Art

Electronic equipment such as a mobile phone may be provided with a display device displaying time, characters and the like in matrix arrangement of a plurality of LEDs (Light Emitting Diode). One LED in the display device in which the LEDs are arranged in a matrix state corresponds to a dot, which is a minimum display unit. Thus, in order to have desired display made on the display device, brightness of each LED needs to be set. FIG. 6 is an example of an LED driving circuit 900 driving a dot matrix LED 800 in which LEDs are arranged in a matrix of 7 rows and 17 columns (See Japanese Patent Laid-Open No. 2003-158300, for example). The LED driving circuit 900 is a circuit for dynamic driving of the dot matrix LED 800 on the basis of a command and data inputted from a microcomputer 810 and includes a gradation data storage unit 910, an IF (Interface) circuit 911, a controller 912, a scan line driver 913, and a data line driver 914. The gradation data storage unit 910 is a memory circuit for storing gradation data indicating brightness of the LED for each LED in the dot matrix LED 800. The IF circuit 911 transfers the gradation data outputted from the microcomputer 810, a driving command instructing driving start of the LED and the like to the controller 912. The controller 912 stores the inputted gradation data corresponding to each LED in the gradation data storage unit 910. If the driving command is inputted, the controller 912 controls the gradation data storage unit 910, the scan line driver 913, and the data line driver 914 so that the driving of the dot matrix LED 800 is started. Specifically, the controller 912 controls the scan line driver 913 so that scan lines 1A to 7A of the dot matrix LED 800 are sequentially selected on the basis of the driving command. Moreover, the controller 912 sequentially reads the gradation data in the gradation data storage unit 910 and outputs it to the data line driver 914 so that each of the LEDs connected to the selected scan line is driven on the basis of the corresponding gradation data. As a result, the data line driver 914 outputs a driving current according to the gradation data to each of the data lines 1B to 17B. Therefore, the dot matrix LED 800 emits light at the brightness according to the gradation data in the gradation data storage unit 910.

As mentioned above, the brightness of the LED in the dot matrix LED 800 is set on the basis of the gradation data stored for each LED. Therefore, for fine setting of the LED brightness, the number of bits in the gradation data needs to be increased. However, if the number of bits in the gradation data is increased, there is a problem that a memory capacity of the gradation data storage unit 910 is increased.

### SUMMARY OF THE INVENTION

A light-emitting element driving circuit according to an aspect of the present invention, comprises: an index data storage unit configured to store n-bit index data for each of a plurality of light-emitting elements included in a display device, the n-bit index data specifying a storage location of gradation data indicating brightness of a light-emitting element in the plurality of light-emitting elements: a gradation data storage unit configured to store the gradation data with m bits larger than n bits, corresponding to the index data; and a driving circuit configured to drive the light-emitting element on the basis of the gradation data corresponding to the index data so that the light-emitting element emits light at brightness according to the gradation data.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating an LED driving circuit 20, which is an embodiment of the present invention;

FIG. 2 is a diagram for explaining a configuration of an index data storage unit 50;

FIG. 3 is a diagram for explaining a configuration of a gradation data storage unit 51;

FIG. 4 is a diagram illustrating an embodiment of a data line driving circuit 39;

FIG. 5 is a diagram illustrating an embodiment of a driving current generating circuit 60; and

FIG. 6 is a diagram illustrating an example of the LED driving circuit for driving a dot matrix LED.

### DETAILED DESCRIPTION OF THE INVENTION

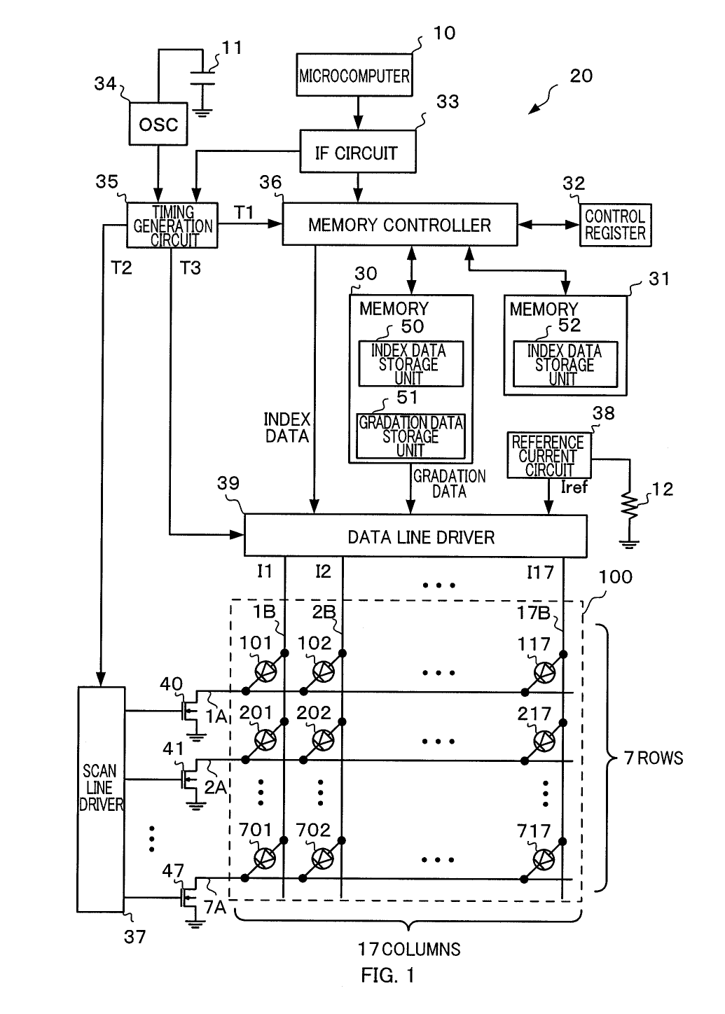

At least the following details will become apparent from descriptions of this specification and of the accompanying drawings. FIG. 1 is a diagram illustrating a configuration of an LED driving circuit 20, which is an embodiment of the present invention. The LED driving circuit 20 is a circuit for dynamic driving of a dot matrix LED 100 according to a command and data outputted from a microcomputer 10. The LED driving circuit 20 includes memories 30, 31, a control register 32, an IF circuit 33, an oscillation circuit (OSC) 34, a timing generation circuit 35, a memory controller 36, a scan line driver 37, a reference current circuit 38, a data line driver 39, and NMOS transistors 40 to 47. The LED driving circuit 20 in this embodiment is supposed to be integrated. Also, the dot matrix LED 100 with 7 rows and 17 columns in this embodiment includes 7 scan lines 1A to 7A, 17 data lines 1B to 17B, and 119 LEDs 101 to 117, 201 to 217, 301 to 317, 401 to 417, 501 to 517, 601 to 617, 701 to 717 arranged in 7 rows and 17 columns. To each of the 7 scan lines 1A to 7A, cathodes of the LEDs arranged in the first row (LEDs 101 to 117) to the LEDs arranged in the seventh row (LEDs 701 to 717) are connected. Also, to each of the 17 data lines 1B to 17B, anodes of the LEDs arranged in the first column (LED 101 to 701) to the LEDs arranged in the seventeenth column (LED 117 to 717) are connected. As mentioned above, the dot matrix LED 100 of this embodiment is dynamically driven. Therefore, though the details will be described later, the scan lines 1A to 7A are sequentially selected, and to each of the LEDs connected to the selected scan line, a driving current according to desired brightness is supplied. Also, a display device configured by the microcomputer 10, a capacitor 11, a resistor 12, the LED driving circuit 20, and the dot matrix LED 100 of this embodiment is supposed to be provided in a mobile phone in order to display time, characters and the like, for example. Also, the IF circuit 33, the oscillation circuit (OSC) 34, the timing generation circuit 35, the memory controller 36, the scan line driver 37, the reference current circuit 38, the data line driver 39, and the NMOS transistors 40 to 47 correspond to a driving circuit.

The memory 30 is a writable memory circuit such as a register and a RAM (Random Access Memory) and includes an index data storage unit 50 and a gradation data storage unit 51.

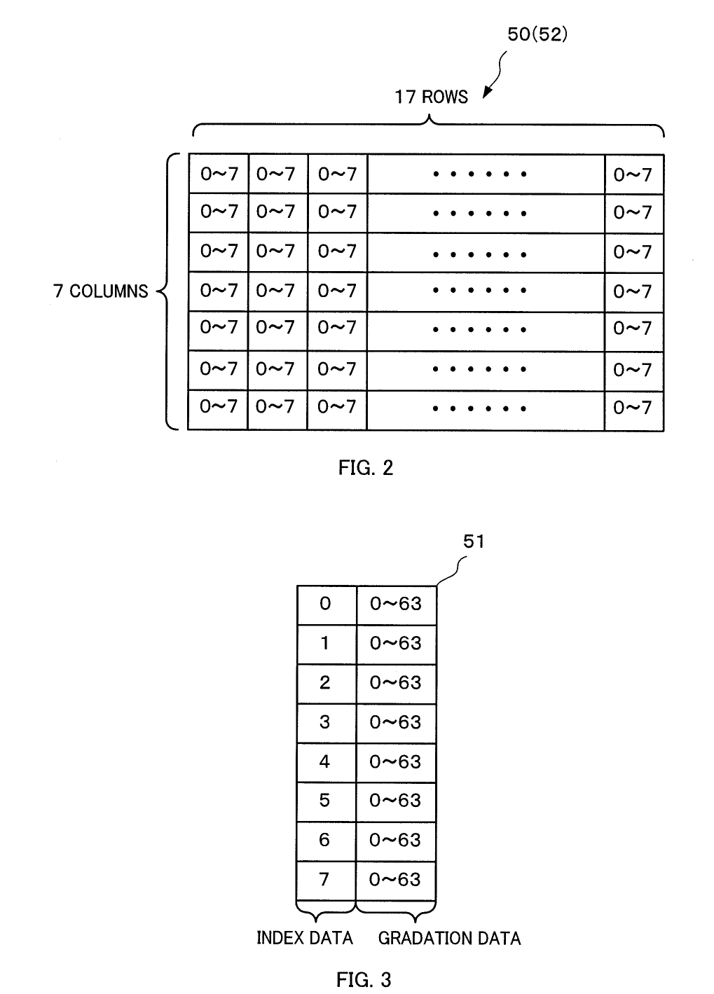

The index data storage unit 50 (first storage unit) stores, as shown in FIG. 2, index data specifying a storage location of gradation data indicating brightness of the LED in the dot matrix LED 100 for each LED. In this embodiment, the index data is supposed to be 3-bit data, for example. Thus, the index data storage unit 50 stores a value of any of 0 to 7 (decimal number) according to the 3-bit data in a storage region allocated to each LED of the dot matrix LED 100. Therefore, the index data storage unit 50 includes the above-mentioned storage regions in 7 rows and 17 columns. Also, in this embodiment, the index data stored in the storage region of the first row and the first column corresponds to the index data of the LED 101, and the index data stored in the storage region of the first row and the second column corresponds to the index data of the LED 102, for example. As mentioned above, the index data stored in the storage region of the n-th row and the m-th column of the index data storage unit 50 corresponds to the index data of the LED arranged on the n-th row and the m-th column. In this embodiment, the index data stored in the storage region of the n-th row and the m-th column is index data (n, m).

The gradation data storage unit 51 stores the gradation data in accordance with the index data. The gradation data in this embodiment is supposed to be 6-bit data, for example. Also, the gradation data storage unit 51 is, as shown in FIG. 3, configured by 8 storage regions which can store 6-bit gradation data. In FIG. 3, the 6-bit gradation data stored in the first row, for example, is the gradation data corresponding to the index data “0” (decimal number), and the 6-bit gradation data stored in the second row is the gradation data corresponding to the index data “1” (decimal number). In this way, in this embodiment, the gradation data corresponding to the index data values of “0” to “7” (decimal number) become the data stored in each of the first to eighth rows. Also, each of the gradation data stored in the gradation data storage unit 51 is outputted to the data line driver 39.

The memory 31 is a writable memory circuit such as a register, a RAM and the like, similarly to the memory 30, and includes an index data storage unit 52.

The index data storage unit 52 (second storage unit) stores, similarly to the index data storage unit 50, index data for specifying a storage location of the gradation data indicating brightness of the LED in the dot matrix LED 100 for each LED. The index data storage units 50 and 52 correspond to an index data storage unit.

The control register 32 (control data storage unit) stores control data for allowing the memory controller 36 to select either one of the index data storage unit 50 and the index data storage unit 52 to store the index data. The control data in this embodiment is supposed to be 1-bit data, for example, and if the control data is “0”, the memory controller 36 selects the index data storage unit 50 as a storage location of the index data, while if the control data is “1”, the memory controller 36 selects the index data storage unit 52 as the storage location of the index data. In this embodiment, in the storage region for storing each of the index data, the gradation data, and the control data, predetermined addresses are supposed to be allocated. The control data “0” corresponds to first control data, while the control data “1” corresponds to the second control data.

The IF circuit 33 transfers the index data, the gradation data, and the control data inputted from the microcomputer 10 to the memory controller 36. Also, the IF circuit 33 transfers a driving command instructing driving start of the dot matrix LED 100 inputted from the microcomputer 10 to the timing generation circuit 35.

The oscillation circuit 34 is a circuit for generating a clock signal with a cycle according to a capacity value of the capacitor 11.

The timing generation circuit 35 stores the driving command in the register (not shown) included in the timing generation circuit 35 if a driving command is inputted from the IF circuit 33. Also, the timing generation circuit 35 controls the memory controller 36, the scan line driver 37, and the data line driver 39 so that the dot matrix LED 100 is dynamically driven on the basis of the driving command and the clock signal. Specifically, the timing generation circuit 35 outputs timing signals T1 to T3 on the basis of the driving command and the clock signal to each of the memory controller 36, the scan line driver 37, and the data line driver 39.

The memory controller 36 stores the control data inputted from the IF circuit 33 in the control register 32 and the gradation data inputted from the IF circuit 33 in the gradation data storage unit 51. Also, on the basis of the control data stored in the control register 32, the controller stores the index data inputted from the IF circuit 33 in either of the index data storage units 50 or 52. Specifically, if the control data stored in the control register 32 is “0”, the memory controller 36 stores the index data in the index data storage unit 50. On the other hand, if the control data stored in the control register 32 is “1”, the memory controller 36 stores the index data in the index data storage unit 52. Also, the memory controller 36 obtains the index data stored in either of the index data storage units 50 or 52 on the basis of the timing signal T1 from the timing generation circuit 35 and sequentially outputs it to the data line driver 39 so that the dot matrix LED 100 is dynamically driven. The memory controller 36 in this embodiment obtains the index data from the index data storage unit 52 if the control data is “0” and obtains the index data from the index data storage unit 50 if the control data is “1”. Also, if the memory controller 36 is to output the index data of the index data storage unit 50, for example, the controller sequentially outputs the index data of the adjacent columns of the same row such that the index data (1, 1) in the index data storage unit 50 is outputted, first, and then, the index data (1, 2), (1, 3) are outputted. Also, if the index data (1, 17) is outputted, the memory controller 36 obtains and outputs the index data (2, 1) of the first column in the subsequent row. In this way, the memory controller 36 obtains the index data (1, 1) of the first row and the first column and sequentially outputs it by row. Then, if the index data (7, 17) of the seventh row is outputted, the memory controller 36 obtains the index data of the first row again and sequentially outputs it. Output from the memory controller 36 of the index data stored in the index data storage unit 52 is the same as the case of the index data storage unit 50.

The scan line driver 37 is a circuit to sequentially turn on the NMOS transistors 40 to 47 on the basis of the timing signal T2 from the timing generation circuit 35. In this embodiment, drains of the NMOS transistors 40 to 47 are connected to each of the scan lines 1A to 7A, and sources are connected to the ground GND. Therefore, if the NMOS transistor 40 is turned on, for example, the scan line 1A in the scan lines 1A to 7A becomes substantially equal in potential to the ground GND. In a state in which the scan line 1A is equal in potential to the ground GND, that is, while the scan line 1A is selected, if the data line driver 39 outputs a driving current to the data lines 1B to 17B, the driving current flows through the LEDs 101 to 117 connected to the scan line 1A. In this case, the driving current does not flow through the LED connected to the scan lines 2A to 7A which were not selected. Also, the scan line driver 37 sequentially turns on the NMOS transistors 40 to 47 on the basis of the timing signal T2, and the scan lines 1A to 7A of the dot matrix LED 100 in this embodiment are sequentially selected.

The reference current circuit 38 is a circuit for generating a reference current Iref to be a reference of a driving current outputted by the data line driver 39 to the data lines 1B to 17B according to a resistance value of the resistor 12.

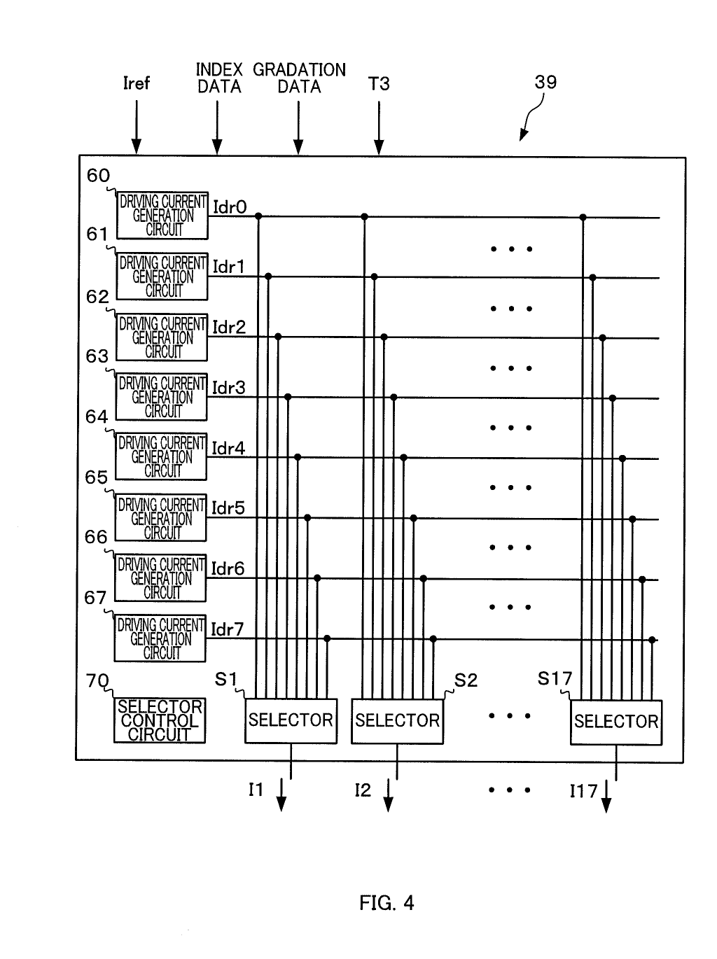

The data line driver 39 is a circuit for outputting driving currents I1 to I17 according to the reference current Iref, the index data, and the gradation data to the data lines 1B to 17B on the basis of the timing signal T3 from the timing generation circuit 35. The data line driver 39 is, as shown in FIG. 4, configured by driving current generation circuits 60 to 67, a selector control circuit 70, and selectors S1 to S17. The driving current generation circuits 60 to 67 correspond to the driving signal output circuit, and the selector control circuit 70 and the selectors S1 to S17 correspond to a selection circuit.

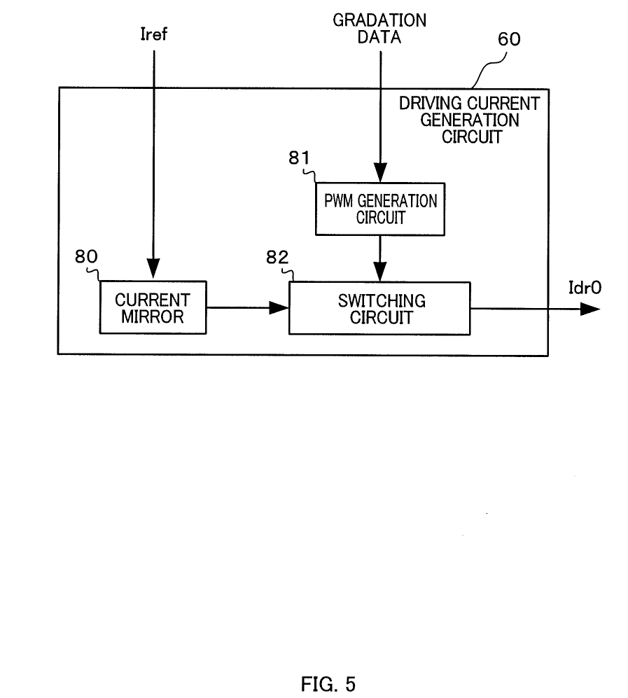

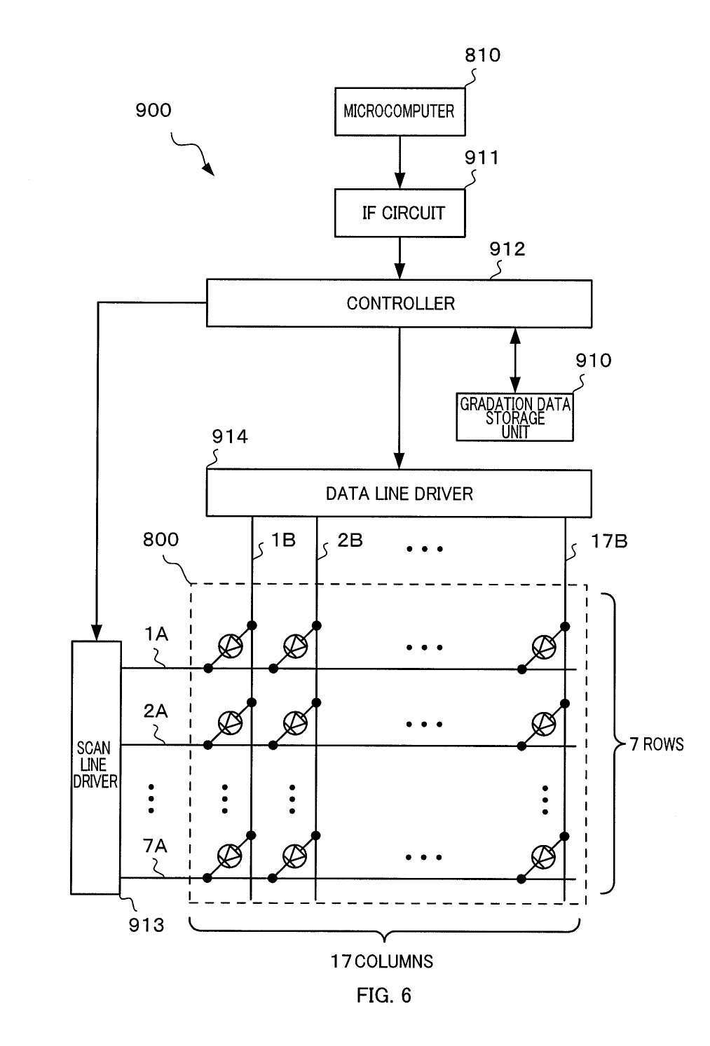

The driving current generation circuit 60 is a circuit for generating a driving current Idr0 according to the gradation data stored in the storage region of the gradation data storage unit 51 corresponding to the index data “0” (decimal number) and the reference current Iref. The driving current generation circuit 60 includes, as shown in FIG. 5, for example, a current mirror 80, a PWM (Pulse Width Modulation) generation circuit 81, and a switching circuit 82.

The current mirror 80 is a circuit which generates a current according to the inputted reference current Iref and outputs it to the switching circuit 82.

The PWM generation circuit 81 is a circuit for outputting a PWM signal with a duty ratio according to the gradation data to the switching circuit 82. In this embodiment, if the gradation data is “0” (decimal number), for example, a high level (hereinafter referred to as H level) duty ratio of the PWM signal becomes zero, and the H-level duty ratio is supposed to be raised according to an increase of a value of the gradation data. If the gradation data is “63” (decimal number), the H-level duty ratio of the PWM signal is supposed to become 100%.

The switching circuit 82 is a circuit for changing a current from the current mirror 80 according to the H-level duty ratio of the PWM signal and outputting it as the driving current Idr0. In this embodiment, if the H-level duty ratio of the PWM signal is zero, a current value of the driving current Idr0 becomes the minimum value, that is, zero, and the current value of the driving current Idr0 is supposed to be increased according to the increase of the H-level duty ratio of the PWM signal. Also, if the H-level duty ratio of the PWM signal becomes 100%, the driving current Idr0 becomes the maximum value, that is, Imax.

The driving current generation circuits 61 to 67 generate, similarly to the driving current generation circuit 60, the driving currents Idr1 to Idr7 according to the gradation data stored in the storage region of the gradation data storage unit 51 corresponding to each of the index data “1” to “7” (decimal number) and the reference current Iref.

The selector control circuit 70 stores the index data sequentially outputted from the memory controller 36 in the order of output. If one row of index data in the index data storage unit 50, that is, 17 pieces of the 3-bit index data are stored, for example, at timing on the basis of the timing signal T3, the 17 pieces of index data are outputted to each of the selectors S1 to S17. The timing to output the one row of index data by the selector control circuit 70 is set so that it becomes the same timing as any one of the scan lines 1A to 7A is selected. As mentioned above, the memory controller 36 in this embodiment sequentially outputs the index data in the adjacent columns from the index data (1, 1) on the first row. Therefore, in the selector control circuit 70, the index data in any of the first to seventh rows is stored as the one row of index data. If the index data on the first row of the index data storage unit 50 is stored in the selector control circuit 70, for example, the index data (1, 1) to the first row and the first column is outputted to the selector S1. Also, the index data (1, 2) to the first row and the second column to the index data (1, 17) to the first row and the seventeenth column are outputted to each of the selector S2 to the selector S17. The same applies to the case in which the index data on another row is stored in the selector control circuit 70. Also, the output of the index data from the index data storage unit 52 is also the same as the output from the index data storage unit 50. Also, in this embodiment, after the selector control circuit 70 outputs the one row of index data, the memory controller 36 sequentially outputs the index data on the subsequent row on the basis of the timing signal T2. Therefore, the selector control circuit 70 of this embodiment can be realized by providing a storage region storable of one row of index data, for example.

The selector S1 stores the index data outputted from the selector control circuit 70, selects any one of the driving currents Idr0 to Idr7 from the driving circuits 60 to 67 on the basis of the stored index data, and outputs it as the driving current I1 to the data line driver 39. If the index data with the value “0” (decimal number) is stored, for example, the selector S1 selects the driving current Idr0 as the driving current I1. Also, if the value of the index data is “1” to “7”, each of the driving currents Idr1 to Idr7 is selected as the driving current I1. The selector S1 of this embodiment includes a register (not shown) storing the 3-bit index data outputted from the selector control circuit 70, and the register is supposed to be updated each time the index data is outputted from the selector control circuit 70. Also, as mentioned above, to the selector S1, the index data to the first column in the 17 pieces of the index data for one row stored in the selector control circuit 70 is outputted. Thus, the index data (1, 1) to (7, 1) are repeatedly stored in the register of the selector S1.

The selectors S2 to S17 select, similarly to the selector S1, the driving currents Idr0 to Idr7 on the basis of the value of the index data corresponding to the second row to the seventeenth row in the 17 pieces of index data for one row stored in the selector control circuit 70. Then, each of the selectors S2 to S17 outputs the driving currents I2 to I17.

### Example of Fade-In/Fade-Out of Predetermined Display

An example of an operation of the LED driving circuit 20 if predetermined display in the dot matrix LED 100 is faded in/faded out will be described. Here, the LED driving circuit 20 has the dot matrix LED 100 display time of “12:00” for example, as predetermined display. In this embodiment, the time “12:00” is displayed by having the LED corresponding to the storage region storing the index data “1” (decimal number) emit light and by having the LED corresponding to the storage region storing the index data “0” (decimal number) not emit light. Also, here, the index data to display “12:00” is stored in the index data storage unit 50. Moreover, in the storage regions corresponding to the index data “0” and “2” to “7” (decimal number) in the gradation data storage unit 51, the gradation data “0” (decimal number) is stored, while in the storage region corresponding to the index data “1” (decimal number), the gradation data “63” (decimal number) is stored. Therefore, the current value of the driving current Idr0 of the driving current generation circuit 60 and the current values of the driving currents Idr2 to Idr7 of each of the driving current generation circuits 62 to 67 are zero. On the other hand, the current value of the driving current Idr1 of the driving current generation circuit 61 is Imax.

First, to the microcomputer 10, a driving instruction of the dot matrix LED 100 is inputted from a system microcomputer (not shown) controlling a mobile phone (not shown) in a centralized manner. The microcomputer 10 outputs a driving command to the IF circuit 33 so that the driving of the dot matrix LED 100 is started. The IF circuit 33 transfers the driving command to the timing generation circuit 35. The timing generation circuit 35 controls each of the memory controller 36, the scan line driver 37, the data line driver 39 by the timing signals T1 to T3 so that the dot matrix LED 100 is dynamically driven on the basis of the driving command. As a result, first, the memory controller 36 obtains the index data stored in the index data storage unit 50 and sequentially outputs it to the data line driver 39. As a result, in the selector control circuit 70, the index data is sequentially stored. And at timing when the 17 pieces of index data on the first row in the index data storage unit 50 are stored in the selector control circuit 70, the timing generation circuit 35 has the selector control circuit 70 output the 17 pieces of index data to each of the selectors S1 to S17. As mentioned above, the index data used for displaying “12:00” is “0” or “1” (decimal number). Therefore, the selectors S1 to S17 select and output either one of the driving current Idr0 corresponding to the index data “0” (decimal number) and the driving current Idr1 corresponding to the index data “1” (decimal number). Specifically, in the 17 pieces of index data on the first row, for example, if only the index data (1, 3) to the third column is “1” (decimal number) and the other index data is “0” (decimal number), only the driving current 13 outputted from the selector S3 in the selectors S1 to S17 becomes the driving current Idr1. On the other hand, the driving currents I1, I2, I4 to I17 of the other selectors S1, S2, S4 to S17 are the driving current Idr0. That is, only the current value of the driving current I3 is the current value Imax, while the current values of the driving currents I1, I2, I4 to I17 are zero. The timing generation circuit 35 of this embodiment has the selector control circuit 70 output the 17 pieces of index data on the basis of the timing signal T3 and has the scan line driver 37 turn on the NMOS transistor 40 on the basis of the timing signal T2. Therefore, the driving currents I1 to I17 flow through each of the LEDs 101 to 117 on the first row in the dot matrix LED 100. Thus, if only the above-mentioned index data (1, 3) is “1” (decimal number), for example, only the LED 103 through which the driving current I3 flows in the LEDs 101 to 117 emits light, while the LEDs 101, 102, 104 to 117 do not emit light. Also, as mentioned above, the timing generation circuit 35 controls each of the memory controller 36, the scan line driver 37, the data line driver 39 so that the dot matrix LED 100 is dynamically driven. Thus, each time the 17 pieces of index data to each row in the index data storage unit 50 is stored in the selectors S1 to S17, an operation to turn on the NMOS transistor on the corresponding column is repeated. As a result, “12:00” is displayed on the dot matrix LED 100.

Subsequently, if an instruction to fade out the display of “12:00” is inputted from the system microcomputer (not shown) controlling the mobile phone (not shown) in a centralized manner, for example, the microcomputer 10 outputs gradation data for fade-out for having the display of “12:00” fade-out. Here, the gradation data for fade-out is data such that a value of the gradation data to the index data “1” (decimal number) in the graduation data storage unit 51 is decremented one by one from “63” to “62”, “61”, and “60” (decimal number) to “0” in the end. The gradation data for fade-out is inputted to the gradation data storage unit 51 through the IF circuit 33 and the memory controller 36. As a result, the value of the gradation data to the index data “1” (decimal number) in the data storage unit 51 is decremented one by one. As a result, the current value of the driving current Idr1 outputted from the driving current generation circuit 61 is decreased according to the value of the gradation data from the current value Imax to zero in the end. Also, while the value of the gradation data is decreased, the scan line driver 37 and the data line driver 39 continue to dynamically drive the dot matrix LED 100. Therefore, the display of “12:00” in the dot matrix LED 100 is faded out according to the decrease of the value of the gradation data to the index data “1” (decimal number).

Also, an operation of the LED driving circuit 20 in the case of fade-in after the display of “12:00” is faded out, for example, as mentioned above will be described. First, a fade-in instruction is inputted from the system microcomputer (not shown) controlling the mobile phone (not shown) in a centralized manner. As a result, the microcomputer 10 outputs predetermined gradation data in order to have a value of the gradation data to the index data “1” (decimal number) become a value according to the fade-in instruction. If a fade-in instruction to have the display of “12:00” emit light the most brightly is inputted to the microcomputer 10, for example, the microcomputer 10 outputs the gradation data with the value of “63” (decimal number). The gradation data with the value of “63” (decimal number) is stored in the storage region to the value of the index data in the gradation data storage unit 51 of “1” through the IF circuit 33 and the memory controller 36. Also, while the gradation data with the value of “63” (decimal number) is stored, the scan line driver 37 and the data line driver 39 continue to dynamically drive the dot matrix LED 100. Therefore, the display of “12:00” in the dot matrix LED 100 is faded in at desired brightness since the value of “63” is stored in the storage region to the value of the index data of the gradation data storage unit 51 of “1”.

### Example of Operation to Switch Display of Dot Matrix LED 100

Here, an example of an operation of the LED driving circuit 20 when display in the dot matrix LED 100 is switched. Here, the LED driving circuit 20 displays characters of “Mail” indicating that the mobile phone (not shown) has received an e-mail from time of “12:00”, for example, as predetermined display on the dot matrix LED 100. Here, as mentioned above, by having the LED corresponding to the storage region storing the index data “1” (decimal number) emit light and by having the LED corresponding to the storage region storing the index data “0” (decimal number) not emit light, “12:00” or “Mail” is displayed. Also, in the storage regions corresponding to the index data “0” and “2” to “7” (decimal number) of the gradation data storage unit 51, the gradation data “0” (decimal number) is stored, while in the storage region corresponding to the index data “1” (decimal number), the gradation data “63” (decimal number) is stored. Therefore, the current value of the driving current Idr0 of the driving current generation circuit 60 and the current values of the driving currents Idr2 to Idr7 of each of the driving current generation circuits 62 to 67 are zero. On the other hand, the current value of the driving current Idr1 of the driving current generation circuit 61 is Imax.

First, the microcomputer 10 outputs index data to have “12:00” displayed subsequent to the control data “0” (decimal number). As a result, the index data to display “12:00” is stored in the index data storage unit 50. Also, the microcomputer 10 outputs the index data to display “Mail” subsequent to the control data “1” (decimal number). As a result, the index data to display “Mail” is stored in the index data storage unit 52. Then, if an instruction to drive the dot matrix LED 100 is inputted to the microcomputer 10 from the system microcomputer (not shown), the microcomputer 10 outputs a driving command to the timing generation circuit 35 so that driving of the dot matrix LED 100 is started. In this case, since the control data “1” is stored in the control register 32, the memory controller 36 obtains the index data stored in the index data storage unit 50 and outputs it to the data line driver 39. As a result, “12:00” is displayed on the dot matrix LED 100. When an instruction to change the display on the dot matrix LED 100 from “12:00” to “Mail” is inputted to the microcomputer 10 from the system microcomputer (not shown), the microcomputer 10 outputs the control data “0” to the IF circuit 33. When the memory controller 36 stores the control data “0” in the control register 32, the memory controller 36 obtains the index data stored in the index data storage unit 52 and outputs it to the data line driver 39. As a result, “Mail” is displayed on the dot matrix LED 100.

Also, if time is changed from “12:00” to “12:01” while “Mail” is being displayed, the microcomputer 10 outputs index data to display “12:01” to the IF circuit 33. As a result, on the basis of the control data “0”, the memory controller 36 stores the index data to display “12:01” in the index data storage unit 50. Thus, the LED driving circuit 20 can display “12:01” immediately when the instruction to display time again is inputted from the microcomputer 10.

The index data storage units 50 and 52 of this embodiment with the configuration as mentioned above store the 3-bit index data indicating a storage location of the gradation data indicating brightness of each LED of the dot matrix LED 100 for each LED. Also, the gradation data storage unit 51 stores the 6-bit gradation data corresponding to the index data. The LED driving circuit 20 drives the dot matrix LED 100 on the basis of the 6-bit gradation data corresponding to the 3-bit index data. Therefore, in this embodiment, brightness that can be used at the same time for each LED in the dot matrix LED 100 is limited to 8 types of 3 bit, but brightness of each LED can be changed in 64 stages of 6 bit. Thus, the LED driving circuit 20 of this embodiment can set brightness finely while suppressing increase of the memory capacity as compared with the case of storage of the 6-bit gradation data for each LED in the dot matrix LED, for example. Also, if the gradation data is stored for each LED in the dot matrix LED, for example, all the gradation data corresponding to the LED to emit light need to be changed for fade-out/fade-in of the predetermined display. However, in this embodiment, in the case of fade-out/fade-in of the predetermined display, it is only necessary to change the gradation data corresponding to the index data to have the LED emit light as mentioned above. Therefore, in this embodiment, visually smoother fade-in/fade-out can be realized. Moreover, if the gradation data is stored for each LED in the dot matrix LED, for example, the microcomputer 10 needs to output all the gradation data of the LEDs to emit light to the IF circuit 33 for the predetermined display. In this embodiment, the microcomputer 10 outputs only the gradation data corresponding to the index data to have the LED emit light to the IF circuit 33. Therefore, the LED driving circuit 20 of this embodiment can suppress a data transfer amount.

Also, in order to drive the dot matrix LED in general, a driving current generation circuit for generating a driving current according to the gradation data needs to be provided in the same number as the number of data lines. In this embodiment, each of the eight driving current generation circuits 60 to 67 outputs the driving currents Idr0 to Idr7 on the basis of the gradation data corresponding to the index data. Also, the driving currents Idr0 to Idr7 are inputted to the selectors S1 to S17, and the selectors S1 to S17 select the inputted driving currents Idr0 to Idr7 on the basis of the index data in the index data storage units 50 and 52. As a result, from the selectors S1 to S17, the driving currents I1 to I17 are outputted to each of the 17 data lines 1B to 17B. Therefore, circuit scale can be reduced in this embodiment as compared with the case of using the same number of driving current generation circuits as the number of data lines.

The memory controller 36 of this embodiment stores the index data in the index data storage unit 50 if the control data is “0” and obtains the index data from the index data storage unit 52. On the other hand, if the control data is “1”, the memory controller 36 stores the index data in the index data storage unit 52 and obtains the index data from the index data storage unit 50. Also, the data line driver 39 drives the dot matrix LED 100 according to the index data outputted from the memory controller 36. Therefore, the LED driving circuit 20 of this embodiment makes predetermined display on the dot matrix LED 100 and can also store the index data for making another display. Thus, as mentioned above, it is possible to immediately switch the display between “12:00” and “Mail”, for example, only on the basis of the inputted control data. If the index data stored in the index data storage unit is to be updated to switch the display from “12:00” to “Mail”, for example, the display is not switched until transfer of the index data to display “Mail” is completed. Therefore, when the switching of display by updating the index data stored in the index data storage unit is compared with this embodiment, this embodiment can change the display quickly and smoothly.

The above embodiments of the present invention are simply for facilitating the understanding of the present invention and are not in any way to be construed as limiting the present invention. The present invention may variously be changed or altered without departing from its spirit and encompass equivalents thereof.

The LED driving circuit 20 of this embodiment drives the dot matrix LED 100 consisting of general LED, but a dot matrix LED made up of an organic EL (Electroluminescence) element can be driven, for example. Also, the LED driving circuit 20 of this embodiment may drive an LED of 7-segment display, for example.

What is claimed is:

1. A light-emitting element driving circuit comprising:
an index data storage unit configured to store n-bit index data for each of a plurality of light-emitting elements included in a display device, the n-bit index data specifying a storage location of gradation data indicating brightness of a light-emitting element in the plurality of light-emitting elements:
a gradation data storage unit configured to store the gradation data with m bits larger than n bits, corresponding to the index data; and
a driving circuit configured to drive the light-emitting element on the basis of the gradation data corresponding to the index data so that the light-emitting element emits light at brightness according to the gradation data.

2. The light-emitting element driving circuit according to claim 1, wherein
the driving circuit includes:
a driving signal output circuit configured to output a driving signal for driving the light-emitting element according to the gradation data in the gradation data storage unit for each index data; and
a selection circuit configured to select and output to the light-emitting element the driving signal outputted for each index data on the basis of the index data in the index data storage unit so that the light-emitting element emits light at brightness according to the gradation data.

3. The light-emitting element driving circuit according to claim 1, wherein
the index data storage unit includes:
a first storage unit capable of storing the index data of the n bits for each of the plurality of light-emitting elements; and
a second storage unit different from the first storage unit, the second storage unit capable of storing the index data of the n bits for each of the plurality of light-emitting elements, and wherein
the light-emitting element driving circuit further comprises a control data storage unit configured to store either one of first control data for storing the index data in the first storage unit and second control data for storing the index data in the second storage unit, and wherein
the driving circuit drives the light-emitting element on the basis of the gradation data corresponding to the index data stored in the second storage unit and stores in the first storage unit the index data which is inputted if the first control data is stored in the control data storage unit, and drives the light-emitting element on the basis of the gradation data corresponding to the index data stored in the first storage unit and stores in the second storage unit the index data which is inputted if the second control data is stored in the control data storage unit.

4. The light-emitting element driving circuit according to claim 2, wherein
the index data storage unit includes:
a first storage unit capable of storing the index data of the n bits for each of the plurality of light-emitting elements; and
a second storage unit different from the first storage unit, the second storage unit capable of storing the index data of the n bits for each of the plurality of light-emitting elements, and wherein
the light-emitting element driving circuit further comprises a control data storage unit configured to store either one of first control data for storing the index data in the first storage unit and second control data for storing the index data in the second storage unit, and wherein the driving circuit drives the light-emitting element on the basis of the gradation data corresponding to the index data stored in the second storage unit and stores in the first storage unit the index data which is inputted if the first control data is stored in the control data storage unit, and drives the light-emitting element on the basis of the gradation data corresponding to the index data stored in the first storage unit and stores in the second storage unit the index data which is inputted if the second control data is stored in the control data storage unit.
